(19) United States
(12) Patent Application Publication
(10) Pub. No.: US 2009/0296863 A1
(43) Pub. Date: Dec. 3, 2009

(54) Interference Estimator

(75) Inventors: Olav Emerik Tirkkonen, Helsinki (FI); Klaus Hugl, Helsinki (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/363,292

(22) Filed: Jan. 30, 2009

(30) Foreign Application Priority Data
Jan. 30, 2008 (GB) 0801685.9

(51) Int. Cl. H04B 1/10; H04B 17/00

(52) U.S. Cl. 375/346; 455/226.1

(57) ABSTRACT

A method of detecting a data stream comprising estimating a data stream from a received signal, generating an interference estimate based on said estimated data stream, detecting the data stream using said interference estimate.

### RELATED APPLICATIONS

This application claims the benefit of Great Britain Application No. 0801685.9 filed Jan. 30, 2008, which is hereby incorporated by reference in its entirety.

### FIELD OF THE INVENTION

The present invention relates to a method and apparatus and, in particular but not exclusively, to an improved method of estimating interference for use in a wireless telecommunications network.

### BACKGROUND

It has been proposed to improve the capacity of communication by use of spatial diversity or spatial multiplexing. By using spatial multiplexing, the data rate can be increased by transmitting independent information streams from different antennas but using the same channel as defined by frequency, time slot and/or spreading code.

These systems may be referred to as multiple input multiple output (MIMO) systems. These systems require complex controllers to control both the transmission and receiving elements of both the base station and the mobile station.

Multi-stream single user MIMO transmission has been proposed and forms part of WCDMA, 3GPP LTE and WiMax system standards. In order to receive multi-stream transmission, a MIMO receiver has to be applied in order to allow the separation and detection of the spatially multiplexed data streams using multiple antennas and receiving circuitry.

One of the receiver architectures that has been proposed for this purpose is the MMSE-SIC (Minimum Mean Square Error-Serial Interference Cancellation) receiver. This receiver has been extensively used e.g. in 3GPP for performance evaluations of WCDMA and 3GPP LTE. As a consequence, this receiver can be regarded as a state-of-the-art implementation of a multi-stream MIMO receiver.

In contrast to single-user MIMO mentioned above, for multi-user (MU) MIMO, data streams are transmitted to several terminals in the same physical transmission resource by space division multiple access (SDMA). Multi-user MIMO is has been proposed to be part of future 3GPP LTE and WiMax standards. In this case, the receiver only needs to receive and decode the transmitted signal intended for itself. However, the remaining streams, intended for other terminals in the communications system is effectively noise in the same code and/or frequency space as the desired signal. Therefore, the estimation and cancellation of noise for the received channel may be necessary in order to receive the required data stream.

The conventional methods to estimate noise and interference in MIMO systems can be roughly classified into two categories.

A first category of noise estimation methods is sample matrix inversion, in which the covariance matrix of the received signal is estimated. This covariance matrix is then projected against the channel of the desired signal. The resulting combining weights suppress the dominant subspace of the interference.

For methods applying the sample matrix inversion technique, the interference covariance is an estimate of the realized interference that has disturbed the received data signal. However, the estimate is unreliable as the estimation is disturbed by the desired signal. When the number of samples used in the estimation is large, the effect of the desired signal diminishes and a good estimate may be obtained. However, when the number of samples used in the estimation is small, the effect of the desired signal has not been sufficiently averaged, and the quality of the resulting estimate is poor. In that case, the interference rejecter will rejects part of the desired signal as well leading to poor performance.

A second category of methods is based on pilot transmissions, the interference covariance is estimated from the pilot transmissions relating to the desired signal. In these transmissions, the desired signal is known (after channel estimation), and the interference covariance can be estimated directly.

For pilot transmission methods, in the case of stationary interference, the interference covariance is estimated without disturbance from the desired signal, and is thus of better quality than the sample matrix covariance estimate. However, if the interference experienced in the pilot transmissions does not have the same spatial characteristics as the interference experienced by the received data signal, the estimated covariance may not reflect the actual interference experienced. A number of circumstances that would cause this to happen are:

A connected cell and an interfering cell are operating asynchronously, and the network load is not constant. In each interfering cell, there are potentially two interfering transmission time intervals (TTIs) that interfere with the TTI of the own cell. The interference estimate is then an estimate of the loads realized during the pilot transmissions. (This is a typical scenario in LTE)

The interfering and connected cells are operating synchronously, and beam-forming techniques are used in the interfering cells. In this case, the interference estimate is made from common pilot transmissions of the interfering cell, whereas the realized interference comes from interfering cell beams.

The interfering and connected cells are operating asynchronously, beam-forming is used in the interfering cell, and the scheduled user in the interfering cell is changed from TTI-to-TTI. Then the interference estimate is made from the realized interference of the interfering TTIs that overlap with the pilot transmissions. (This is a typical scenario in LTE)

If the dominant interference is caused by multi-user MIMO transmission in the connected cell. In this case there is no interference to be estimated from the desired signal pilot transmissions.

These considerations lead to the conclusion that an interference estimate derived from the received data signal samples, as e.g. in case of sample matrix inversion, may be the most suitable technique for interference rejection in a MIMO system. However, with sample matrix inversion specifically, the quality of the interference covariance estimation is a serious problem.

FIG. 1 shows a prior art MMSE-SIC receiver structure which is applied for dual-stream or dual-codeword transmission as extensively discussed in 3GPP. In the receiver structure, the received signal, y, is applied to an input of a first MMSE/IRC Receiver 2, the signal is also applied to interference estimator 4, channel estimator 6, and adder 10. An estimate of the noise and interference present in the signal is made at the interference estimator 4, and this estimate is provided to the first MMSE/IRC Receiver 2. The channel estimator 6 provides a channel estimate Hest to the first MMSE/IRC Receiver 2. The Receiver 2 uses the interference estimate and the channel estimate to extract an estimate of the first data stream s1est from the received signal. The signal s1est is then deinterleaved and decoded in Deinterleaving Decoder 14 to provide the data stream s1.

In order to simplify reception of a second data stream s2, the signal s1est is also provided to Convolver 12 where the signal is convolved with the channel estimate h1est for the channel of the first data stream. The resultant signal is then subtracted from the received signal, y, in adder 10, to remove the first data stream from the received signal. The output of adder 10 is provided to a second MMSE/IRC Receiver 8, which also receives a channel estimate h2est for the channel of the second data stream from the channel estimator 6, and an estimate of the interference from interference estimator 4. The output of the second MMSE/IRC Receiver 8 is a estimate of the second data stream s2est which may then be deinterleaved and decoded in second Deinterleaving Decoder 16 to provide the second data stream s2.

In operation, the user equipment (UE) receives the signals:

$$y = HS + n = [ h 1 h 2 ] [ \begin{matrix}s 1 \\ s 2\end{matrix} ] + n ,$$

where capitals stand for matrices and normal letters for vectors. H denotes the channel matrix and h1 and h2 the channel of the first and second spatially multiplexed data stream, respectively. The first stream is decoded using the noise and interference estimate available from the received signal y to detect the data signals s1. The soft-decisions or hard-decisions (depending on the specific SIC implementation) are again remodulated and convolved with the channel estimate of h1 to create an estimate of the part of the data signals h1s1 in the received signal which are subtracted from the total received signal:

y2=y−h1s1=h2s2+(h1s1−ĥ1ŝ1)+n

which is then used by the second receiver 8 to detect the data of the second stream. The purpose of this arrangement is to remove the interference effect of the first data stream in the detection of the second data stream after the first stream has been detected.

In FIG. 2, a receiver architecture with post-decoding serial interference cancellation is depicted. The operation of this circuit is similar to that of FIG. 1. However, in this architecture the estimate of the s1-part of the signal is generated after decoding in decoder 14 and then, re-encoding, re-interleaving and remodulation in Encoder 18.

In an architecture according to the architecture in FIG. 1, the estimate of the s1-part of the signal is generated after demodulation, but without decoding. In this case, some non-linear demodulation-remodulation decision device is used when estimating the s1-part of the signal.

The most practical receiver for single stream reception in case of rank1 SU-MIMO (Single-User MIMO) and MU-MIMO (Multiple-User MIMO) is the IRC (Interference Rejection Combining) receiver. For the IRC receiver it is necessary to estimate the interference and noise covariance matrix at the user equipment. The performance of the IRC and also MMSE receiver is very much dependent on the quality of the noise and interference estimate.

The noise and interference estimation may be especially difficult in case of MU-MIMO transmission, if the UE is not aware of the spatial-temporal structure of the multi-user interference, as this may not be signaled to the user equipment, for example as in 3GPP LTE.

It is an aim of some embodiments of the present invention to address, or at least mitigate, some of these problems.

### SUMMARY

According to a first aspect of the present invention there is provided a method of detecting a data stream comprising estimating a data stream from a received signal, generating an interference estimate based on said estimated data stream, and detecting the data stream using said interference estimate.

According to an embodiment of the present invention, estimating the data stream may comprise generating an initial estimate of interference, wherein said data stream estimate may be detected based on said initial estimate of interference. Estimating the data stream may further comprise calculating an estimate of the channel, wherein said estimate may be detected based on said channel estimate. Generating the interference estimate may comprise combining said estimate of the data stream with said channel estimate to create an estimate of the part of the data stream present in the received signal. Generating the interference estimate may further comprise subtracting the estimate of the part of the data stream present in the received signal from the received signal to cancel the estimated part of the data stream present in the received signal. Generating the interference estimate may further comprise generating said interference estimate based on the received signal having had the estimated part of the data stream present in the received signal cancelled.

According to a second aspect of the present invention, there is provided an apparatus comprising a first receiver configured to estimate a data stream based on a received signal, an interference estimator configured to generate an estimate of interference based on said estimated data stream, and a second receiver configured to detect the data stream using said estimate of interference.

The apparatus may further comprise an initial interference estimator configured to generate an initial estimate of interference, wherein said first receiver may be further configured to estimate said data stream based on said initial estimate of interference. The apparatus may further comprise a channel estimator configured to calculate an estimate of the channel, wherein said first receiver may be further configured to estimate said data stream based on said channel estimate. The apparatus may further comprise a convolution configured to convolve said estimate of the data stream with said channel estimate to create an estimate of the part of the data stream present in the received signal. The apparatus may further comprise an adder configured to subtract said estimate of the part of the data stream present in the received signal from the received signal to thereby cancel the estimated part of the data stream present in the received signal. The apparatus may further comprise an interference estimator configured to generate an estimate of interference based on an output of said adder.

The said apparatus may comprise a user equipment, a base station, or a chipset for use in a radio modem.

According to one embodiment of the present invention, the apparatus may further comprise a first switch configured to select an input to said interference estimator, said switch operable to select between the received signal and a signal based on said estimated data stream. The apparatus may further comprise a second switch configured to select an input to said second receiver, said switch operable to select between a signal corresponding to a first MIMO layer and a signal corresponding to a second MIMO layer. The apparatus may further comprise a third switch operable to cause said interference estimator to provide said interference estimate, and to cause said second receiver to detect said data stream, if an error is detected in said estimate of the data stream.

According to a further embodiment of the present invention, the apparatus may be operable to provide serial interference rejection combining when receiving a single stream signal in a first mode of operation, and to provide successive interference cancellation when receiving a multistream signal in a second mode of operation.

According to a third aspect of the present invention, there is provided a computer program comprising program code means adapted to perform any of the above described method when the program is run on a processor.

According to a fourth aspect of the present invention, there is provided an apparatus comprising first receiving means for estimating a data stream based on a received signal, interference estimating means for generating an estimate of interference based on said estimated data stream, and second receiving means for detecting the data stream using said estimate of interference.

### BRIEF DESCRIPTION OF THE DRAWINGS

The present invention is now described by way of example only with reference to the accompanying Figures, in which:

FIG. 1 shows a prior art serial interface cancellation receiver;

FIG. 2 shows a prior art serial interface cancellation receiver with post-decoding;

FIG. 3 shows an example serial interface rejection receiver according to one embodiment of the present invention;

FIG. 4 shows a post-decoding serial interface rejection receiver according to a further embodiment of the present invention.

FIG. 5 illustrates a flow diagram of a method according to one embodiment of the present invention

FIG. 6 shows one example system in which embodiments of the present invention may be implemented.

### DESCRIPTION OF PREFERRED EMBODIMENTS

Embodiments of the present invention are described herein by way of particular examples and specifically with reference to preferred embodiments. It will be understood by one skilled in the art that the invention is not limited to the details of the specific embodiments given herein.

For a user equipment that has a MMSE-SIC receiver implemented, the SIC part is not used during reception of a single stream transmission, for example rank1 SU-MIMO transmissions or MU-MIMO transmissions, where only a single data stream is intended per user equipment.

In some embodiments of the present invention the available MMSE-SIC structure is utilized in order to improve the available interference estimation and thereby improve the detection probability of single stream reception.

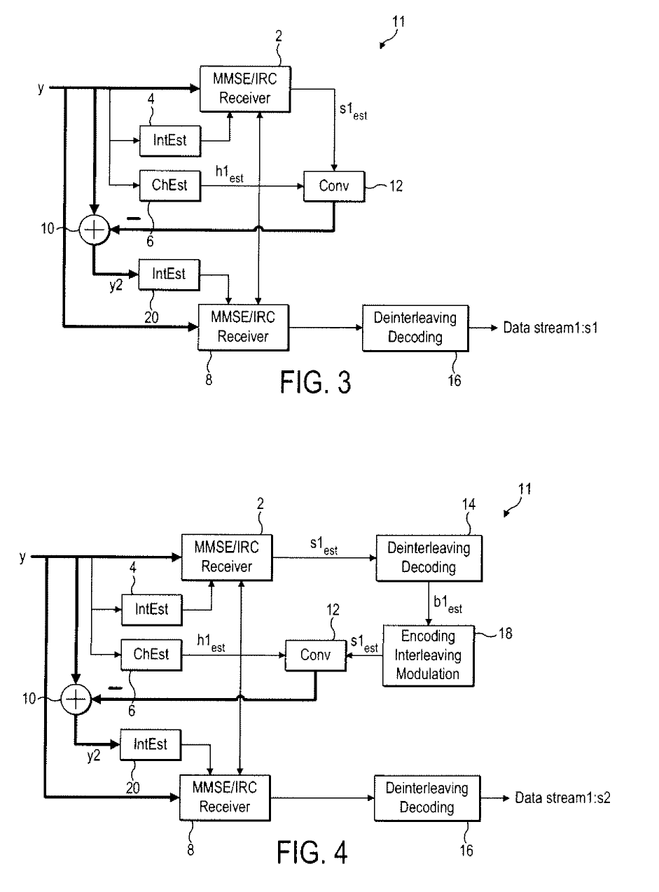

One embodiment is shown in FIG. 3. In this embodiment an attempt is made to first decode the data stream with a conventional/state-of-the-art interference estimator (e.g. such as described above). If the detection is found not to be reliable (e.g. if errors are detected), the available SIC structure may be used to create an improved input to the interference estimator.

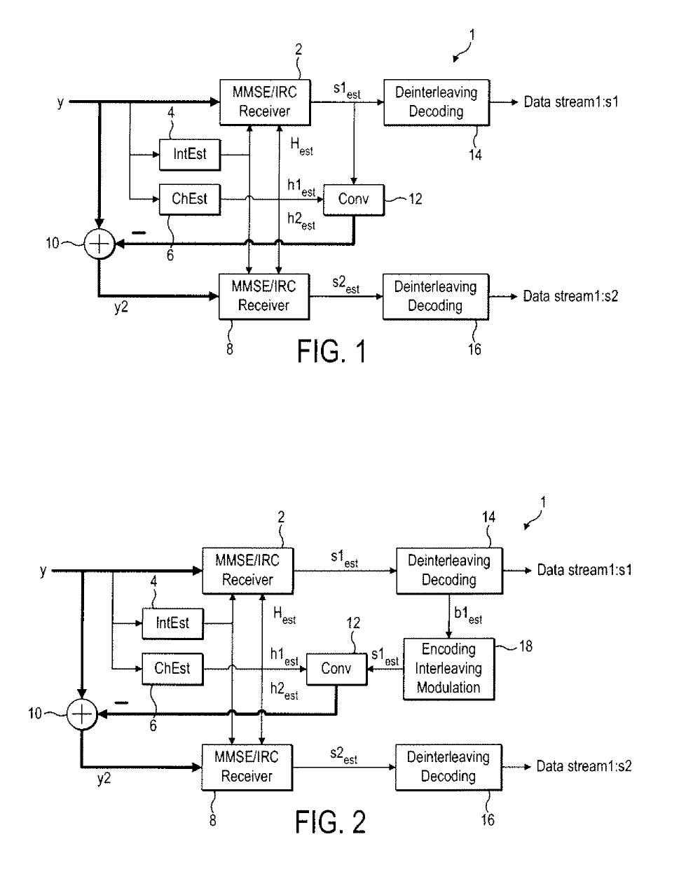

The embodiment of the invention shown in FIG. 3 uses similar functional blocks to the prior art receiver described in relation to FIG. 1. In the receiver structure, the received signal, y, is applied to an input of a first MMSE/IRC Receiver 2, the signal is also applied to interference estimator 4, channel estimator 6, and adder 10. An estimate of the noise and interference present in the signal is made at the interference estimator 4, and this estimate is provided to the first MMSE/IRC Receiver 2. The channel estimator 6 provides a channel estimate h1est to the first MMSE/IRC Receiver 2. In contrast to the prior art system, when used to receive a single stream the channel estimate will be the channel for that stream only. The Receiver 2 then uses the interference estimate and the channel estimate to extract an estimate of the first data stream s1est from the received signal.

To provide an improved interference estimate, in accordance with some embodiments of the present invention, the signal s1est is also provided to Convolver 12 where the signal is convolved with the channel estimate h1est. The resultant signal output from convolver 12 is then subtracted from the received signal, y, in adder 10, to generate an improved quality input, y2, where:

y2=y−h1s1=(h1s1−ĥ1ŝ1)+n

In case of MU-MIMO, multi-user interference is present in the noise and interference term n, whereas in case of single user transmission only the noise and inter-cell interference will be present. In contrast to the system of FIG. 1, this signal y2 is then used to create an improved noise and interference estimate in a second interference estimator 20. This improved noise and interference estimate may then be used to run the MMSE/IRC receiver 8 for the data stream, using the improved interference estimate.

A further embodiment of the invention is shown in FIG. 4. In this embodiment, the first estimate of the data stream, s1est, is decoded in decoder 14, and is then re-encoded, and remodulated in encoder 18. The re-encoded estimate of the data stream s1est is then convolved in convolver 12 as described in relation to the system of FIG. 3.

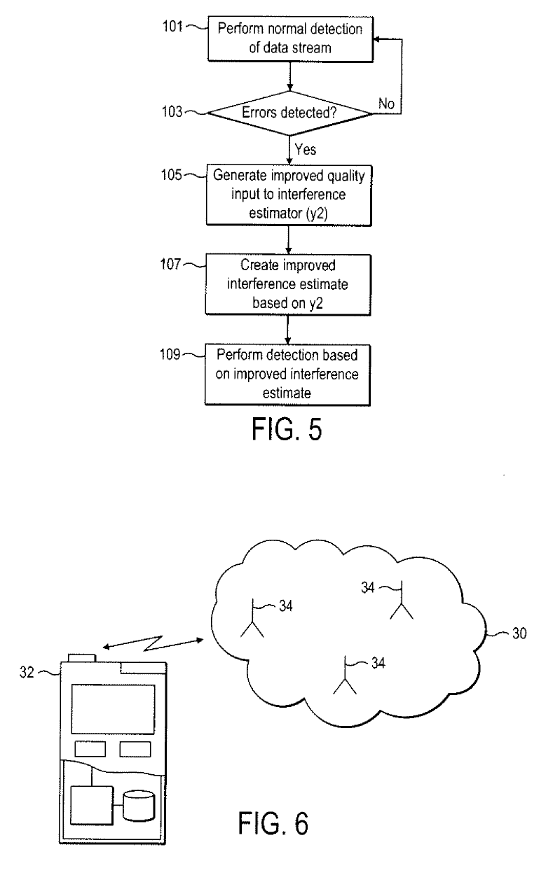

FIG. 5 illustrates a method of receiving a data stream according to one embodiment of the present invention. In step 101 detection of the single data stream s1 is performed using the prior art techniques as outlined above. If, in step 103, it is determined that the data stream has been recovered incorrectly, for example through the detection of errors in the data stream, the SIC structure may be used to generate an improved quality input, y2, to the second interference estimator 20, step 105. The improved quality input, y2, is then used to create an improved interference estimate in step 107. In step 109, detection of the data stream s1 may then be performed again in second receiver 8, using the improved interference estimate.

In one exemplary embodiment of the invention, FEC (forward error correction) codes may be used to determine whether the data stream is being received correctly. According to another embodiment, the interference estimate may comprise a noise and interference covariance matrix. Whilst in the described embodiment, the improved interference estimate is only used when errors are detected in the first estimate of the received data stream, s1est, in other embodiments the receiver may be configured to always generate and use the improved interference estimate to detect the data stream s1.

Many of the components of the disclosed receiver exist in the prior art MMSE/SIC receiver for use in the receipt of multiple data streams. Some embodiments of the present invention re-use these components to provide improved detection of the single received stream. In order to operate the components in accordance with some embodiments of the present invention, it may be necessary to include a number of switches in the receiver that make it possible to use the same receiver components for serial interference rejection combining. Switches that may be necessary to modify the prior art receivers to perform embodiments of the present invention may include:

A switch that selects the input to the second interference estimation circuit 20. This switch selects at least from the alternatives of taking the input from a received signal, y, directly, or taking the input from a signal with at least part of the “own signal” cancelled, y2.

A switch that selects the input to the second MMSE/IRC receiver 8. The switch may select from at least the alternatives of taking the input corresponding to a second MIMO layer, or corresponding to the first MIMO layer.

A further switch, may be included that generates an estimate of the “desired signal” if the demodulation and decoding of the “own signal” is unsuccessful.

Any such switches may be controlled by a common switching controller. Note that in one exemplary, and non-limiting, implementation, switches to enable the generation of an estimate of the desired signal may not be present at all. The switches of the first two types may be activated automatically during single stream reception so that the improved interference estimation is always used, irrespective of the presence of errors or not in the first estimate of the data stream.

It is not necessary for the described switches to be implemented as physical switches. In one embodiment of the present invention, the switches are implemented in software. The switches may be implemented as part of a chipset in a MIMO modem, wherein a chipset may comprise one or more integrated circuits. More particularly, in one exemplary embodiment of the present invention, the switches may be implemented in the digital baseband portion of a wireless modem.

The disclosed embodiments of the present invention have been described in relation to the reception of a single stream in a dual stream capable receiver. However, embodiments of the present invention may be more generally applicable to receiver architectures capable of receiving greater numbers of data streams. In some embodiments of the present invention, it may be possible to provide a greater number of iterations of data stream estimation in order to provide an interference estimate of increased accuracy.

Some embodiments of the present invention may provide one or more of the following advantages: Improved detection probability for rank 1 SU-MIMO (i.e. single stream SU-MIMO signals) and for MU-MIMO reception. Improved signal detection may lead to lower block error rates in the received data stream and therefore reduced packet delays due to fewer retry's necessary on the network.

Receivers according to some embodiments of the present invention may be more complicated than prior art single stream receivers. However, the necessary components are already present in many MIMO receivers in order to be able to receive multiple data streams. Therefore, improved single stream detection may be implemented in MIMO receivers with minimal extra complexity being introduced.

FIG. 6 shows a communication network 30 in which some embodiments of the present invention may be implemented. In particular, some embodiments of the present invention may relate to the implementation of radio modems for a range of devices that may include: user equipment 32, access points or base stations 34. Furthermore, embodiments of the present invention may be applicable to communication networks implemented according to a range of standards including: WCDMA (Wideband Code Division Multiple Access), 3GPP LTE (Long Term Evolution), WiMax (Worldwide Interoperability for Microwave Access), UMB (Ultra Mobile Broadband), CDMA (Code Division Multiple Access), 1xEV-DO (Evolution-Data Optimized), WLAN (Wireless Local Area Network), UWB (Ultra-Wide Band) receivers.

According to some embodiments of the present invention, the data to be received may be encoded using any forward error correcting scheme (for example the data may be encoded using one or more of: turbo, LDPC, convolution, block, trellis, spherical, space-time, space-time trellis, space-time block and multilevel codes as well as trellis coded modulation, or any parallel or serial concatenation of these). Furthermore, the data may be modulated using according to any known method, including PSK (phase shift keying), QAM (quadrature amplitude modulation), or PAM (phase amplitude modulation). The received data may also be multiplexed using any known method, including one or more of: the frequency, code or time dimensions, or using wavelets or filter banks.

In some embodiments of the present invention, the signal of interest may comprise any number of spatially multiplexed streams, as long as there are dimensions left in the signal space that can be used to reject interference, including a single stream transmission and a single- and multi-codeword multistream transmission. The signal of interest may be transmitted with open loop transmit diversity or a beamforming method, or transmitted with codebook-based precoding. The interference estimation may be performed on a wideband signal, or on a narrowband signal, on a single subcarrier or a cluster of neighbouring subcarriers or all subcarriers in an OFDM signal, on a single spreading code or on the chip-domain signal in CDMA. The estimates in various stages of the receiver can be generated using any method known in the art, including minimum menas square estimation and zero forcing estimation.

It is noted herein that while the above describes exemplifying embodiments of the invention, there are several variations and modifications which may be made to the disclosed solution without departing from the scope of the present invention as defined in the appended claims.

1. A method of detecting a data stream comprising:
estimating a data stream from a received signal;
generating an interference estimate based on said estimated data stream;
detecting the data stream using said interference estimate.

2. The method of claim 1, wherein said estimating the data stream comprises generating an initial estimate of interference, wherein said data stream estimate is detected based on said initial estimate of interference.

3. The method of claim 1, wherein said estimating the data stream further comprises calculating an estimate of the channel, wherein said estimate is detected based on said channel estimate.

4. The method according to claim 3, wherein said generating an interference estimate comprises combining said estimate of the data stream with said channel estimate to create an estimate of the part of the data stream present in the received signal.

5. The method according to claim 4, wherein said generating an interference estimate further comprises subtracting the estimate of the part of the data stream present in the received signal from the received signal to cancel the estimated part of the data stream present in the received signal.

6. The method according to claim 5, wherein said generating an interference estimate further comprises generating said interference estimate based on the received signal having had the estimated part of the data stream present in the received signal cancelled.

7. An apparatus comprising:
a first receiver configured to estimate a data stream based on a received signal;
an interference estimator configured to generate an estimate of interference based on said estimated data stream; and
a second receiver configured to detect the data stream using said estimate of interference.

8. The apparatus of claim 7, said apparatus further comprising an initial interference estimator configured to generate an initial estimate of interference, wherein said first receiver is further configured to estimate said data stream based on said initial estimate of interference.

9. The apparatus of claim 7, said apparatus further comprising a channel estimator configured to calculate an estimate of the channel, wherein said first receiver is further configured to estimate said data stream based on said channel estimate.

10. The apparatus of claim 9, said apparatus further comprising a convolution configured to convolve said estimate of the data stream with said channel estimate to create an estimate of the part of the data stream present in the received signal.

11. The apparatus of claim 10, said apparatus further comprising an adder configured to subtract said estimate of the part of the data stream present in the received signal from the received signal to thereby cancel the estimated part of the data stream present in the received signal.

12. The apparatus of claim 11, said apparatus further comprising an interference estimator configured to generate an estimate of interference based on an output of said adder.

13. The apparatus of claim 7, wherein said apparatus is a user equipment.

14. The apparatus of claim 7, wherein said apparatus is a base station.

15. The apparatus of claim 7, wherein said apparatus is a chipset for use in a radio modem.

16. The apparatus of claim 7, said apparatus further comprising a first switch configured to select an input to said interference estimator, said switch operable to select between the received signal and a signal based on said estimated data stream.

17. The apparatus of claim 7, said apparatus further comprising a second switch configured to select an input to said second receiver, said switch operable to select between a signal corresponding to a first MIMO layer and a signal corresponding to a second MIMO layer.

18. The apparatus of claim 7, said apparatus further comprising a third switch operable to cause said interference estimator to provide said interference estimate, and to cause said second receiver to detect said data stream, if an error is detected in said estimate of the data stream.

19. The apparatus of claim 7, wherein said apparatus is operable to provide serial interference rejection combining when receiving a single stream signal in a first mode of operation, and to provide successive interference cancellation when receiving a multistream signal in a second mode of operation.

20. An apparatus comprising:
first receiving means for estimating a data stream based on a received signal;
interference estimating means for generating an estimate of interference based on said estimated data stream; and
second receiving means for detecting the data stream using said estimate of interference.
